(19) United States
(12) Patent Application Publication
(10) Pub. No.: US 2006/0158154 A1
(43) Pub. Date: Jul. 20, 2006

(54) Method and apparatus for backing up data from cell phones and other hand-held devices

(76) Inventor: Jean R. Maurilus, Baldwin, NY (US)

Correspondence Address: GOTTLIEB RACKMAN & REISMAN PC, 270 MADISON AVENUE, 8TH FLOOR, NEW YORK, NY, 100160601, US

(21) Appl. No.: 11/037,508

(22) Filed: Jan. 18, 2005

(51) Int. Cl. H02J 7/00

(52) U.S. Cl. 320/115

(57) ABSTRACT

A hand-held device, such as a cell phone, a PDA or a digital camera, has a microprocessor, a battery and a primary memory. The hand-held device is coupled to a charger station that has a charging circuit generating charging current and a backup memory. Once the hand-held device and the charger station are coupled, the data from the primary memory is backed up to the backup memory either automatically, or on command from an operator.

### RELATED APPLICATIONS

None

### BACKGROUND OF THE INVENTION

a. Field of Invention

This invention pertains to a method and apparatus that provides data backup for cell phones and other hand-held devices. More specifically, the application pertains to a method and device in which data is stored in the memory of a charger station when the respective device is docked to the station.

b. Description of the Prior Art

In the present invention, unless otherwise specified, the term hand-held device refers generically an electronic device that receives and stores data and has the capability of performing various functions. Electronic devices of this type include cell phones, PDAs, Blackberry-type devices, digital cameras, and so on.

Many hand-held devices receive and store data that is useful to the operator or owner of the device, and may even be required for its proper operation. For example, cell phones are frequently contain telephone listings with the names, telephone numbers, and even addresses of various people or organizations. The owner can selectively recall one of these numbers and request a connection to the recalled number. PDAs and other personal organizers have similar information, and may contain additional data as well, including memos, to do lists, messages and other data files.

Data can also be exchanged between some cell phones and other devices (such as PCs or PDAs) using, for example, a docketing station or wireless means such as an IR beam or a short-range network channel such as Bluetooth, WiFi, etc. This exchange could include backing up data from the cell phone to a PC or PDA. However, the majority of users still enter data into their cell phones by hand.

PDAs can also receive data by manual entry using a native data entry means, such as a keyboard. In addition, most PDAs are provided with either wired or wireless data transfer means for transferring data between PDA and another device such as a PC. The wired transfer means can be a docking station, a cradle or a connector with a standard termination (such as a USB) plug that can be readily plugged into the PC. The data transfer means allows data to be transferred between the PDA and the other device. In addition, wired data transfer means may also provide a charging current to charge the PDA's battery. Data backup from the PDA into the memory of the PC may be provided as part of the data transfer or sync process. In fact, some PDAs are programmed to perform automatic data backup whenever the PDA is connected to the PC.

The ability to store data and then display and manipulate this data provides a major impetus for the use of all the hand-held devices. However, in many instances, the data stored by hand-held devices may be corrupted or even lost. This type of problem may be a result of a mechanical fault, caused by damage to internal components for example, when a hand-held device is bent or dropped, or an electrical fault caused when the hand-held device is inadvertently discharged, subjected to electrical shock, exposed to strong electromagnetic fields, dropped in water, etc. Of course, data loss, diminishes the utility of a hand-held device, and in some cases may even render it inoperable.

Another problem is that if a hand-held device is lost or stolen, the data is lost as well and the user has to re-enter the data in a new device.

U.S. Pat. No. 6,344,727 discloses a charger station for a cell phone. The charger station includes a socket for receiving a removable data storage media, such as memory stick used to store MP3 files.

U.S. Pat. No. 6,804,538 discloses a system for interfacing a cell phone to a PC.

Accordingly, it would be desirable to overcome the above disadvantages.

### SUMMARY OF THE INVENTION

Briefly, the subject application pertains to an assembly consisting of hand-held device and a charger station. The hand-held device includes a microprocessor, a battery and a primary memory storing data used by the operator of the device. The charger station includes means for providing a charging current for charging the battery of the hand-held device and data storage means (such as a backup memory) for backing up data from the primary memory. When the hand-held device is coupled to the charger device, its battery is charged by the charging circuit. At the same time, the data from the primary battery is either just dumped into the backup memory, or the data files in the two memories are synced.

The backup operation is initiated either automatically when the hand-held device and the charger station are coupled or in response to a command. The automatic initiation is triggered either electronically by sensing electrical activity in the connectors between the two elements, or mechanically by using a sensor.

Therefore, if data within the hand-held device is lost or corrupted, it is readily replaced from the memory of the charger station.

Since the memory used for backing up the data is in the charger, an operator need not connect or sync his device with a PC in order to recover lost or corrupted data.

### BRIEF DESCRIPTION OF THE DRAWINGS

FIG. 1 shows in a somewhat diagrammatic form a cell phone being associated with a charger station;

FIG. 2 shows a block diagram of the cell phone and charger station of FIG. 1; and

FIG. 3 shows a block diagram of an alternate embodiment of the invention.

### DETAILED DESCRIPTION OF THE INVENTION

The present invention pertains to hand-held devices that store data useful either for an operator or for the proper operation of the device. The invention is now described in conjunction with the figures, as it relates to a cell phone, it being understood that the invention is applicable to other hand-held device as well.

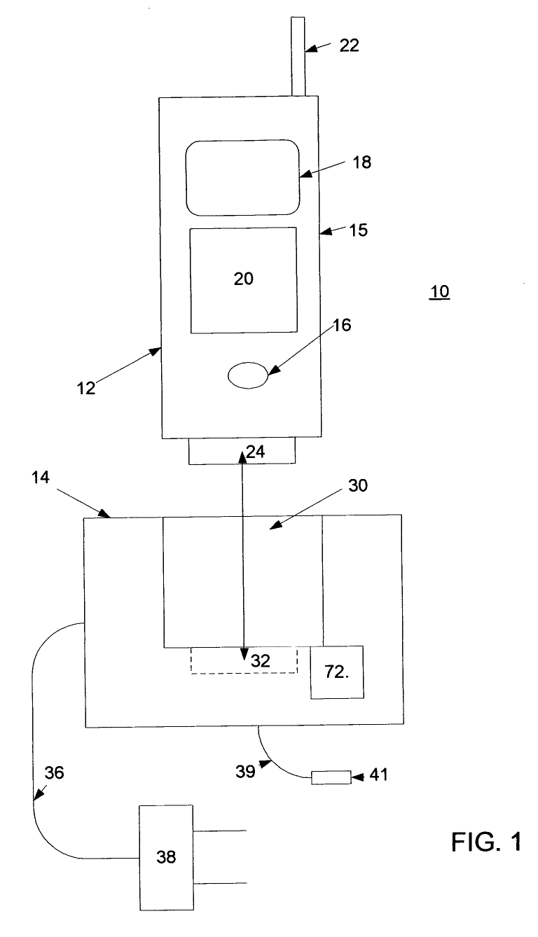

FIG. 1 shows an assembly 10 of a hand-held device 12 and an associated charger station 14. In the embodiment of FIG. 1, the device 12 is preferably a cell phone having a body 15, a microphone 16, a speaker 18, a keyboard 20 and an antenna 22. The cell phone 12 can be used to receive cellular telephone calls via antenna 22 and to initiate cellular telephone calls by manipulating the keys on keyboard 20 (and, optionally, other keys—not shown for the sake of clarity). At the bottom of body 14, there is provided a connector 24.

Charger station 14 includes a cavity 30 with a connector 32. The cavity 30 is sized and shaped to receive at least a portion of the body 15. When the cell phone 12 is in place in the cavity, its connector 24 mates with the connector 32 of cavity 30. The charger station 14 also has a cord 36 terminating with a plug 38 that can be inserted into a standard AC socket. In addition, or instead of cord 36, station 14 can be provided with a connector 39 terminating in a plug 41. The plug 41 may be a USB plug or other similar standard plug that can be connected either to a PC or to another adapter. For example, a USB plug could be connected to an adapter that converts AC into a DC source compatible with the USB standard. This DC source then provides the charging current for the cell phone 12.

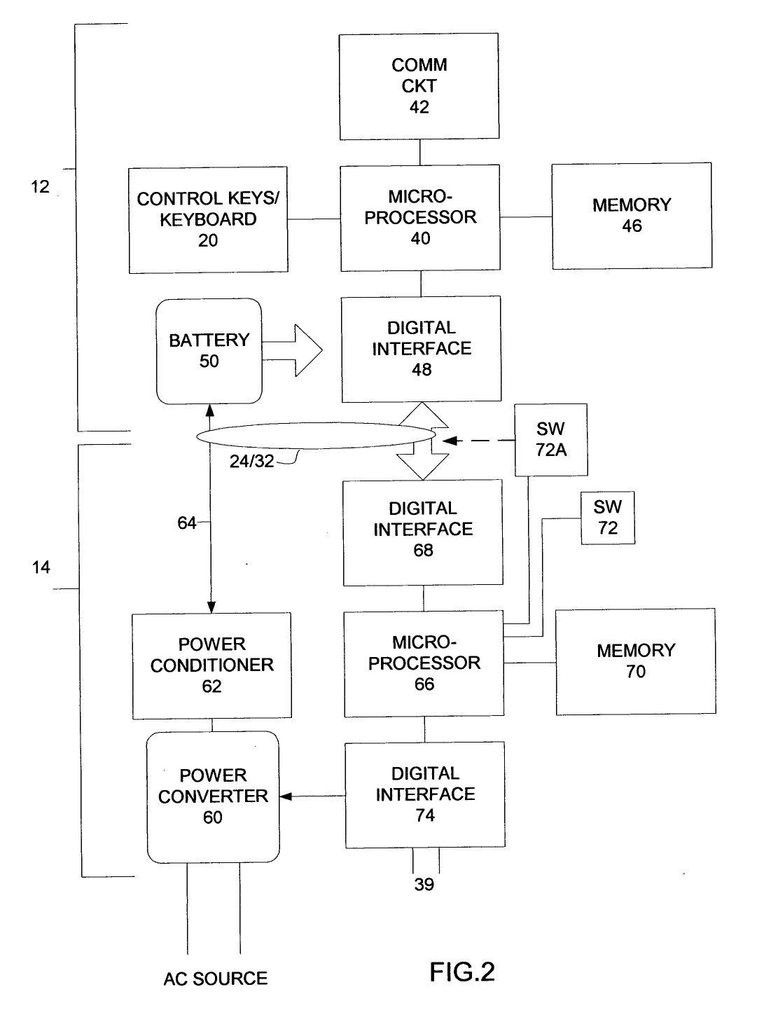

FIG. 2 shows the components of the cell phone 12 and the charger station 14. Some of the components of the cell phone 12 that do not play a part either in the charging function or the data backup function (for example, the microphone 16 and speaker 18) have been omitted for the sake of clarity. As shown in this Figure, cell phone 12 includes a microprocessor 40, a communication circuit 42, keyboard 20, a primary memory 46 and a digital interface 48.

The communication circuit 42 performs the signal processing required to implement cellular telephone communications.

Keyboard 20 is used for dialing telephone numbers, and to generate various control signals operating the cell phone 12. Data, including an address book, and other information used for the operation of the cell phone 12 is stored in memory 46. Data including information from the memory 46 can be exchanged through a digital interface 48.

Power is provided to the various circuitry by the battery 50.

The charger station 14 includes a charging circuit including a power converter 60 that receives AC power and converts into a corresponding DC signal. The DC signal is conditioned or filtered by a signal conditioner 62 (if necessary).

The charger station 14 further includes a microprocessor 66; a digital interface 68, a backup memory 70, and a control switch 72 that may be a momentary or a two-position (on/off) pushbutton 72, or other similar switch means. In one embodiment, a sensor switch 72A is provided that is disposed near the connector 32 to sense when the latter is mated with connector 24.

The assembly 10 operates as follows. Initially, it is assumed that the charger station 14 is connected to an AC source 36 and receives AC signals. When the cell phone 12 is inserted into cavity 30, the connectors 24 and 32 are mated thereby establishing a coupling between digital interfaces 48 and 68. The connectors 24, 32 also provide two or more conductors (not shown) that connect the output 64 to the battery 50. Through this output 64, the power conditioner 62 provides a charging current for charging the battery 50.

According to this invention, once digital communication is established between interfaces 48 and 68, data from memory 46 is backed up into memory 70. The actual backup operation can be implemented as a memory dump or a sync operation. A memory dump consists of transferring either all the content or certain designated data files from memory 46 to memory 70. A sync operation involves comparing data files stored in the two memories 46, 70, and if there is a discrepancy, then transferring only the data files into memory 70 that are missing or outdated. For example, if the two memories contain files having the same name, then the file with the later creation or modification date is the dominant file that replaces the older file. This determination is made either by the microprocessor 40 or microprocessor 68, or the two microprocessors cooperate in the performance of this task.

The backup operation may be initiated in a number of ways. In one embodiment, the interfaces 48, 68 are monitored by either or both microprocessors 40, 68 to detect electronically a coupling between the cell phone 12 and the charger station 14. For example, the microprocessors may detect electrical activity on the conductors (not shown) of the respective interface 48, 68. When a coupling is detected, the backup operation is automatically initiated.

In another embodiment, backup occurs when requested by an operator. The operator can initiate a command for a backup operation either by activating a key on keyboard 20 (or any other key on the cell phone 12 designated for this purpose), or by activating switch 72 on the charger station.

Backup may also be initiated when the switch 72A senses mechanically a mating between connectors 24 and 32 and sends a signal to the microprocessor 66.

Optionally, the charger station 14 has a second digital interface 74. This interface is connected to the connector 39. As described above, this connector may be coupled merely to an adapter (not shown) for providing power to the conditioner 62 and generating the charging current. However, if the connector 39 is connected to another electronic device, such as a PC or a PDA, then data from the memory 46 can downloaded and backed up into either the memory 70 or this other electronic device. Again, this operation may occur under the control of either or both microprocessors 40, 66.

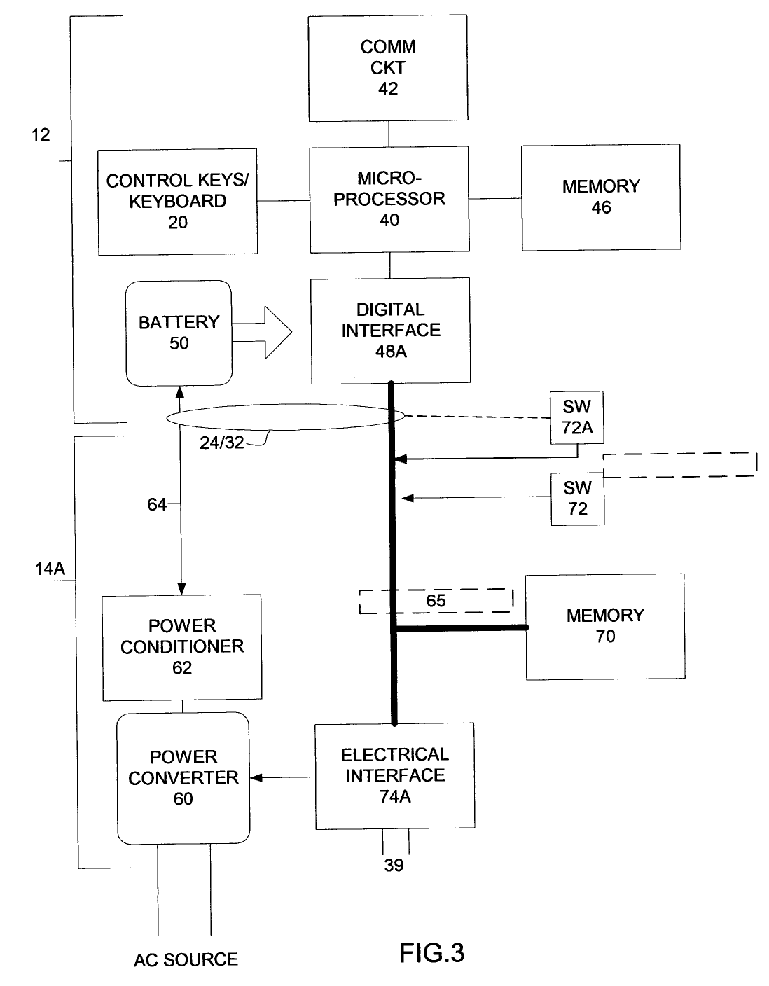

FIG. 3 shows another embodiment of the invention. In this embodiment, the charger station 14A does not have its own microprocessor and therefore all the decisions and control signals are generated by the microprocessor 40. Within the charger station a data bus 65 is provided that connects the memory 70 through the digital interface 48 with the microprocessor 40, thereby making the memory 70 available to the microprocessor. The switches 72, 72A are also connected to this bus 65.

When the cell phone 12 is coupled to the charger station 14A, the battery 50 is charged in the same manner as in the previous embodiment. In addition, the memory 70 becomes available to the microprocessor 40 for data storage. Therefore, the microprocessor 40 can backup data from the memory 70. Again, the backup operation can be initiated either manually or automatically.

When the cell phone 12 is coupled for the first time with the charger station, the data from its memory 46 is backed up into memory 70. More than one cell phone 12 may use the station 14 for charging. In this latter arrangement, either a different memory 70 is dedicated to each cell phone (or each hand-held device) or different files or portions of the memory 70 are used for each cell phone. Thereafter, whenever, a cell phone is coupled to a charger station, it is first identified and associated with the respective memory 70 or memory portion.

Thereafter, every time the cell phone 12 is coupled to the charger station, a determination is first made by either microprocessor to determine whether the contents of memories 46, 70 are identical. If they are not, then the two memories are synced. Alternatively, if the memory contents are not identical, data is automatically transferred from the memory that has the latest data to the other memory.

If a cell phone 12 is coupled to the charger station 14 and it is determined that the data in its memory 46 is corrupted, then this data is replaced by data from memory 70. Moreover, if the original cell phone is lost or stolen and is replaced with a new one, once the new cell phone is coupled to the charger station, the user's data is automatically transferred into the new cell phone. Therefore, the user will not have to re-enter all his data.

The subject invention was described in conjunction with an assembly that includes a cell phone. Of course, the same techniques may also be used to back up data from other hand-held devices as well.

Numerous modifications may be made to the invention without departing from its scope as defined in the appended claims.

I claim:

1. An assembly comprising:
a hand-held device having a primary memory storing data and a battery; and
a charger station with a charging circuit and a backup memory;
wherein said hand-held device is arranged and constructed to be coupled with said charger station; and
wherein said hand-held device and charger station cooperate to charge said battery using said charging circuit and to back up data from said primary memory into said backup memory.

2. The assembly of claim 1 further comprising a microprocessor disposed in one of said hand-held device and said charger station, said microprocessor being programmed to initiate a backup operation of said data.

3. The assembly of claim 2 wherein said microprocessor is adapted to sense when the hand-held device is coupled to said charger station and to initiate in response said backup operation.

4. The assembly of claim 2 wherein said microprocessor is responsive to commands to initiate said backup operation.

5. The assembly of claim 4 further comprising a switch generating said command.

6. The assembly of claim 5 wherein said switch is controlled by an operator.

7. The assembly of claim 5 wherein said switch is a sensing switch that senses that said hand-held device is coupled to said charger station.

8. The assembly of claim 1 wherein said charger station further comprises a connector adapted to selectively connect said charger station to a remote device.

9. The assembly of claim 1 wherein said hand-held device is one of a cell phone, a PDA and a digital camera.

10. An assembly comprising:
a cell phone with a cell phone processor, a battery, and a primary memory with data; and
a charger station dedicated to providing a charging current for said battery and for backing up said data within the charger station, said charger station including charging means generating a charging current for said battery, and data storage means for backing up said data.

11. The assembly of claim 10 wherein said charger station includes a charger microprocessor controlling the data flow through said charger.

12. The assembly of claim 10 wherein said cell phone microprocessor is adapted to backup the data into said backup memory when said cell phone is coupled to said charger station.

13. The assembly of claim 10 further comprising means for determining when said cell phone and said charger station are coupled.

14. The assembly of claim 10 further comprising means for generating a command to initiate the backing up of data.

15. The assembly of claim 10 wherein said means generates commands said command automatically when said cell phone is coupled to said charger station.

16. The assembly of claim 10 wherein said means generates said command in response to an action by an operator.

17. A method of providing data back up for a hand-held device with a primary memory holding data and a battery, comprising:
coupling said hand-held device with a charger station;
charging said battery with a current from said charger station; and
backing up data from said primary memory into a data storage means of said charger station.

18. The method of claim 17 further comprising sensing when said hand-held device is coupled to said charger station and initiating said backing up step in response.

19. The method of claim 17 further comprising initiating said backing up step in response to a command from an operator.

20. The method of claim 17 wherein said charger station is connected to a remote device, further comprising storing data in both a memory in said charger device and sending said data to said remote device.
